(19) United States
(12) Patent Application Publication
(10) Pub. No.: US 2012/0326863 A1
(43) Pub. Date: Dec. 27, 2012

(54) WEARABLE PORTABLE DEVICE AND METHOD

(75) Inventors: Christopher D. Johnson, Niskayuna, NY (US); Radislav A. Potyrailo, Niskayuna, NY (US); Andrew P. Day, Wauwatosa, WI (US); Donald J. Buckley, Niskayuna, NY (US); Susan L. Day, Wauwatosa, WI (US)

(73) Assignee: GENERAL ELECTRIC COMPANY, Schenectady, NY (US)

(21) Appl. No.: 13/169,344

(22) Filed: Jun. 27, 2011

(51) Int. Cl. G08B 1/08; B65D 75/00

(52) U.S. Cl. 340/539.13; 229/87.01

(57) ABSTRACT

A system to receive a portable tracking device on an object is provided. The system includes an encapsulate film surrounding the portable tracking device, and a band having a pocket portion with an open end to receive the portable tracking device and the encapsulate film. The pocket portion includes a flap that folds over the open end of the pocket portion. The encapsulation film can be removed from the band and cleaned without removal of the portable tracking device from the encapsulate film.

### FIELD OF THE INVENTION

This invention generally relates to an apparatus to attach a wearable medical device, and method of disinfection and maintenance.

### BACKGROUND

Hospitals and healthcare facilities can employ asset management practices to streamline operations to reduce overall operation costs. Asset management practices can include tracking utilization of medical equipment (e.g., beds, wheelchairs, carts, laptop computers, imaging systems, etc.) and personnel to be as efficient as possible.

Similar issues exist in other environments where the business relies on ready-use of mobile assets. For instance in an industrial environment, various containers are often moved from one location to the next, with some uncertainty arising regarding a present location of a specific container at any given time. As more employees move containers from one location to another, or move groups of containers so as to access a specific container, the likelihood of a container being misplaced increases. The tracking technology can be useful in other applications, especially those relating to security.

Applications of tracking technology are wide ranging and include detecting objects as they pass near to a sensor, uniquely identifying a specific tracking device such as a tag and associated asset, and communicating data relating to the tracking device to a database for analysis. The process of reading and communicating with tracking device can generally include bringing the tracking device in proximity to a sensor. The tracking devices can include active RFID tags operable to emit an RF signal (or alternatively pulsed beacon), or RFID tags that are passive until illuminated by the radio frequency field of an RFID interrogator, at which point they become responsive. In addition to radio frequency, other types of tracking technology communication mediums can include optical (e.g., frequency or intensity of light), infrared, electromagnetic, ultrasound, etc. or combinations thereof.

Known tracking technology exhibits low durability and often requires substantial replacement costs in large healthcare or industrial settings. For example in healthcare settings, the tracking technology is known to have an increased likelihood of failure associated with cleaning or disinfection of different medical equipment or use by personnel or patients. Another cause for increased likelihood of failure of the tracking technology can be associated with exposure to dirt or other contamination. There is a need for a system to improve a durability of known tracking technology so as to lower the likelihood of failures caused by maintenance, cleaning, disinfection, or sterilization.

### BRIEF DESCRIPTION

The above-mentioned shortcomings, disadvantages and problems are addressed by the embodiments described herein.

In one embodiment of the subject matter described herein, a system to receive a portable tracking device on an object is provided. The system includes an encapsulate film surrounding the portable tracking device, and a band having a pocket portion with an open end to receive the portable tracking device and encapsulate film. The pocket portion includes a flap that folds over the open end of the pocket portion. The encapsulation film can be removed from the band and cleaned without removal of the portable tracking device from the encapsulate film.

In another embodiment of the subject matter described herein, a system to receive a portable electronic device on an object is provided. The system includes an encapsulate film surrounding the location tracking tag; and a band having a pocket portion with an open end to receive the portable electronic device and encapsulate film. The pocket portion further includes a flap that folds over the open end of the pocket portion. The encapsulation film can be removed from the band and cleaned without removal of the portable tracking device from the encapsulate film.

Apparatuses and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of an encapsulate film in combination with a pocket portion of the system enclosing an electronic device in accordance with the subject matter described herein.

FIG. 2 shows a schematic diagram of an embodiment of the system enclosing the electronic device to worn on an appendage of an object in accordance to the subject matter described herein.

FIG. 3 shows a schematic of a portion of the system of FIG. 1 having a thermal mass located between an encapsulate film and electronic device enclosed therein, and an embodiment of a respective temperature profile associated with heat absorption by the thermal mass, in accordance to the subject matter described herein.

FIG. 4 shows a schematic of an embodiment of an external device in communication across the protective encapsulate film of the system with the electronic device enclosed therein, in accordance with the subject matter described herein.

FIG. 5 shows a detailed schematic of an embodiment of a communication coupling across the encapsulate film of the system without penetration of the encapsulate film of the system, in accordance with the subject matter described herein.

### DETAILED DESCRIPTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and is to be understood that other embodiments may be utilized and that logical, mechanical, electrical and other changes may be made without departing from the scope of the embodiments. The following detailed description is, therefore, not to be taken in a limiting sense.

In this document, the terms “a” or “an” are used, to include one or more than one. In this document, the term “or” is used to refer to a nonexclusive or, unless otherwise indicated.

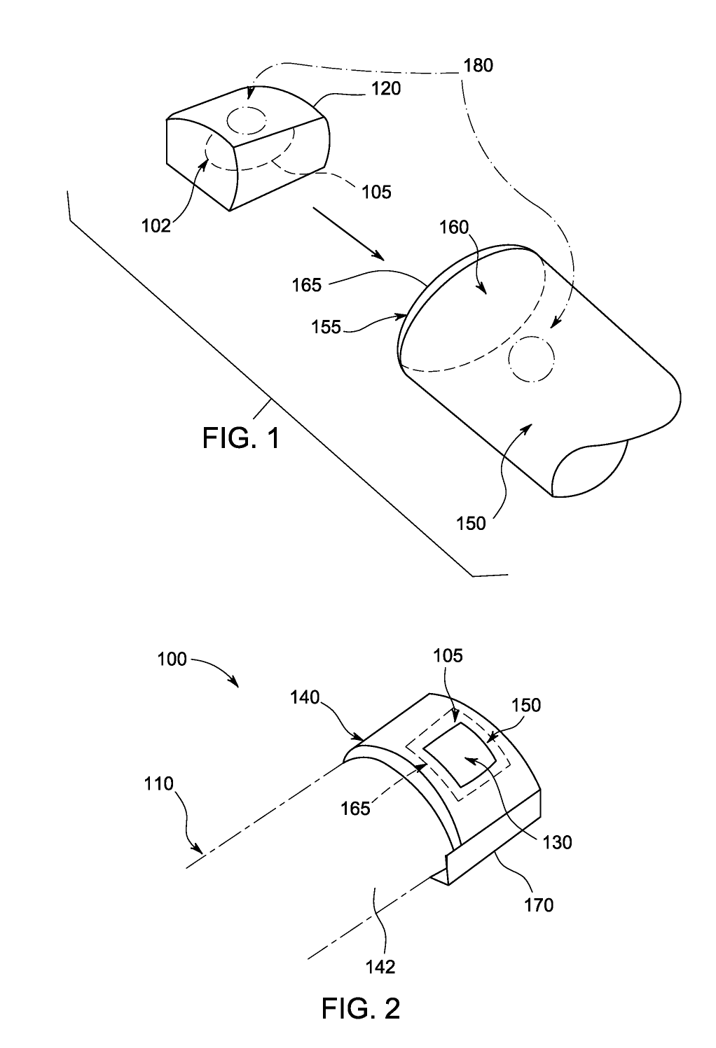

FIG. 1 illustrates an embodiment of a system 100 having a technical effect of encapsulating an electronic device 102 to protect from wear and tear associated with contact or exposure to disinfectants, bodily fluids, or general contamination. One embodiment of the electronic device 102 can include a portable tracking device or tag 105 to be located on or worn by an object 110 (e.g., person (e.g., patient or healthcare employee) or mobile medical equipment) having a location tracked with a location tracking system (not shown) using known tracking technology mediums such as optical, radio frequency (rF), infrared (IR), ultrasound, ultraviolet light, etc.

The embodiment of the system 100 includes a encapsulate film 120 configured to receive the portable location tracking device 105. The encapsulate film 120 can generally be comprised of a waterproof or vaporproof material (e.g., polyethylene, polystyrene, etc.). The material composition of the encapsulate film 120 can be translucent such that a person can visualize the identification of the portable device enclosed therein. The embodiment of the encapsulate film 120 can be generally configured to completely enclose the portable device and prevent penetration or be impervious to fluids and dirt. The embodiment of the encapsulate film 120 can be configured of a material composition to isolate the tracking tag from exposure to sustained mechanical and fluid immersion contact and prevent penetration of antiseptics, disinfectants, and soaps. The embodiment of the encapsulate film 120 can also be configured of a material composition to isolate the tracking tag from exposure to or prevent penetration of plasma gases, ultraviolet light, or radiation exposure.

The material composition of the encapsulate film 120 can be translucent to various tracking technology mediums (e.g., optical recognition, bar code, radio frequency, infrared, ultraviolet light, etc.) so as to allow the tracking device 105 to communicate with a stationary tracking station (e.g., transmitter, receiver or transceiver or combination thereof) of the location tracking system (not shown).

An embodiment of the encapsulate film 120 can be operable to shrink or reduce in size in response to a threshold application of energy (e.g., threshold heat from an application of a stream of hot air blown from a hairdryer, threshold frequency or intensity of light) such that the film can seal the portable device therein from exposure to fluids (e.g., water, vapors, air). The encapsulation of the encapsulate film 120 can be enclosed such that dirt or bacteria cannot penetrate through to reach the tracking tracking device 105 worn on the object 110. An embodiment of the encapsulate film 120 can be applied with various embodiments, including: shrink wrapping with hermetic fusion sealing, wrapping and enclosed with glue, or mechanical interference sealing. The encapsulate film 120 can comprise one or more layers and is not limiting on the subject matter described herein.

An embodiment of the encapsulate film 120 can include a visual indicator or electronically-formatted status indicator stored and retrievable from a non-transitory storage medium representative of a remaining time period of a disinfection status of the tracking device. An embodiment of the encapsulate film 120 can include, solely or in combination with the above, a penetration indicator or electronically-formatted penetration indicator 130 (e.g., an LCD display in communication with a sensor) stored and retrievable representative of a current measure of chemical penetration of any disinfection solvents that have been in contact or penetrated the encapsulate film 120 or made contact with the electronic device 102 enclosed within. The penetration indicator 130 can be operable to generate different visual patterns with a change in measure or detection of penetration of a chemical or disinfection solvent through encapsulate film 120 or contact with the electronic device 102 enclosed therein.

Referring to FIG. 2, the system 100 can further include a band 140 configured to receive the encapsulate film 120 and the location tracking device 105 enclosed therein. The band 140 can be configured to receive or mechanically fasten to an appendage (e.g., wrist, arm, foot) 142 or other part or article such as clothing, dressing, tube, device of object 110 so as to support the location tracking device 105 on the object 110. One embodiment of the band 140 can include a tubular form constructed of material composition operable to encircle or receive the appendage of the object 110.

The material construction of the band 140 can further include a pocket portion or sleeve 150 configured with a flap portion 155. The pocket portion 150 can include an open end 160 to a defined space of the pocket portion 150 generally configured to receive the encapsulated film 120 and tracking device 105 enclosed therein. The pocket portion 150 can be integrally constructed with or attached by mechanical connection device (e.g., Velcro, adhesive, snap connector, etc.) or thermal fusion or chemical bond to the band 140. The flap portion 155 can be integrally constructed to or connected by a mechanical connection device (e.g., Velcro, adhesive, snap connector, etc.) or thermal fusion or chemical bond to the pocket portion 150. The flap portion 155 can be generally configured to overlap the open end 160 so as to restrain the tracking device 105 within the pocket portion 150 of the sleeve 145 of the band 140.

The pocket portion 150 and flap portion 155 of the band 140 can be comprised of a material composition that reduces in size or shrinks in response to receiving an application of a threshold energy (e.g., frequency or intensity of light, increased temperature from application of hot air from a hairdryer, etc.) so as to seal the pocket portion in a manner to inhibit penetration of dirt or debris or splashed fluids (e.g., blood, water) into the pocket portion 150.

The band 140 can be constructed in a similar manner to respond to an application of energy (e.g., blow of warm air from a hair dryer or similar device) so as to tighten or reduce in size around the person's appendage 162. Further, the material composition of the band 140 or the pocket portion 150 and flap portion 155 can be generally translucent so as to allow a person to generally visualize the identification of the electronic device 102 enclosed therein.

The embodiment of the band 140 and/or the pocket portion 150 can be integrally constructed with the encapsulation film 120 or independent thereof, such that the electronic device 102 can be encapsulated directly onto the band 140. The band 140 or pocket portion 150 can also be attached to the encapsulate film 120 by a mechanical connection device (e.g., adhesive, buckle, clamp, Velcro, etc.) 165 as shown in dashed line. The band 140 can be comprised of a similar material composition as that of the encapsulation apparatus so as to shrink or reduce in size in a similar manner in response to a threshold application of energy (e.g., threshold frequency or wavelength or intensity of light, threshold temperature of hot air blown from a hair dryer). In another embodiment, the band 140 can include one or more straps secured around the appendage of the person by a mechanical device (e.g., adhesive, clamp, buckle, Velcro, etc.) 170.

Embodiments of the tracking device 105 can include a receiver, transmitter, or transceiver or combination thereof configured to communicate in a known manner via the tracking technology medium (e.g., optical recognition, bar code, radio frequency, infrared, ultraviolet light, etc.). The tracking device 105 can be employed in combination with stationary sensors to track locations of objects and other desired parameters of the object relative to a predetermined landmark or area. The tracking device 105 can be a passive type that in response to receiving a first signal from a fixed tracking system then transmits a signal with an identifier of the person wearing the tracking device 105. The tracking device can also be an active type that transmits a signal with an identifier of the person wearing the tracking device 105 on a continual or periodic basis.

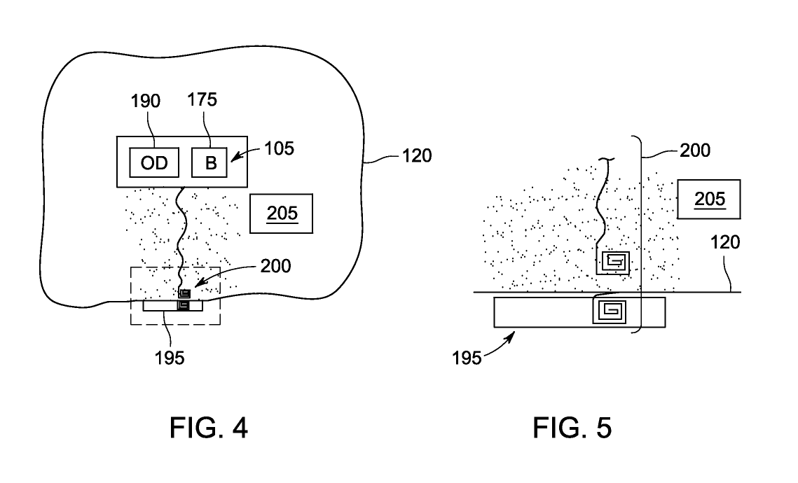

Referring to FIGS. 1, 2 and 4, the electronic device 102 contained in the first encapsulate film 120 and/or the band 140 may include an energy source 175 (See FIG. 4) to power the electronic device 102. The types of energy sources 175 can include a battery, an energy harvesting technology operable to convert motion, vibration, solar energy, thermal energy, radio-frequency energy, etc. to electrical energy to power the tracking tag and/or other sensors employed in combination therewith. The first encapsulate film 120 and/or the band 140 may be further configured to receive paper or other printable medium so as to be printed with an identification code or name of the object wearing the system 100. The band 140 may be marked with a color patterns or combination thereof to provide visual identification. The band 140 may be marked so as register with an optical scanner (not shown). The band 140 may comprise a chemical composition operable to have its color pattern dynamically changed by an internal or external triggering device to indicate a change in state (e.g., expiration of threshold time period between exposure of encapsulate film 120 located therein to disinfection solvents). The band 140 and first encapsulate film 120 may include at least a defined window space 180 (See FIG. 1) translucent so as to transmit a passive RFID or infrared signal or optical signal therethrough that may be continuous, or triggered endogenously or exogenously. The diameter of the band 140 can be variable to be wearable by various types of objects 110, including humans, animals, physical devices, disposable items (e.g., ventilator tubes, central line tubes, and catheter tubes, bandages, dressings, disposable surgical devices, sterilized devices and the like). An embodiment of the band 140 can include a mechanical connection device to avoid re-expansion after shrink fitting.

The electronic device 102 can include sub-components susceptible to an increased probability of failure or improper operation with exposure to disinfectants or bodily fluids or debris, such subcomponents including an output device 190 (See FIG. 4) such as an audible alarm, an LCD screen, a graphic display, etc. The system 100 can also include various types of external devices 195 (see FIG. 4) located external or outside the encapsulate film and/or band 140. Examples of such external devices 195 can include an audible alarm, LCD screen, or visual display as described for the output device 190. The external device 195 can include a sensor operable to record or measure sound, blood sugar level, saturated oxygen levels, temperature, blood pressure, light, electrical conductance, motion or vibration, RF signals, optical signals, infrared signals; a device to create electrical fields at the skin surface; a device to perform position tracking or location (electromagnetic sensors); and a device to detect and store biopotential signals (e.g., pulse, electrocardiogram, etc.) generated by the object 110, or combination thereof. The external devices 195 can also include dispensing mechanisms operable (e.g., via a pump, flow control, skin absorption, etc.) to deliver medication to the object 110.

Referring to FIGS. 4 and 5, the external device 195 can be in communication via a hard-wired coupling or wireless coupling 200 (e.g., RF transmitter/receiver, optical transmitter/receiver, U/S transmitter/receiver, etc.) (See FIGS. 4 and 5) with the electronic device 102 or tracking device 105 enclosed therein. The wireless coupling 200 as shown in greater detail in FIG. 5 does not require penetration of a wire or other hard connection from the external device 195 and through the encapsulate film 120, so as to compromise the encapsulate film 120 in being chemically resistive against penetration of disinfection solvents employed to disinfect in a healthcare environment or clinic setting

Referring again to FIGS. 2 and 4, an example of the external device 195 can include a surface sensor located to provide data to the enclosed electronic device 102 or tracking device 105. In applications with comparatively high power consumption, such as, for example ultrasound, the surface sensor can be connected via coupling 200 that penetrates through an opening in the encapsulate film 120 for connection to the electronic device 102. The surface mounted sensor can be impervious to the temperature, ultraviolet and chemical exposure applied to encapsulate film 120. In embodiments where there is not a comparatively high energy draw, the system 100 can include the RF type coupling 200 (see FIGS. 4 and 5) that does not require an opening in the encapsulate film 120.

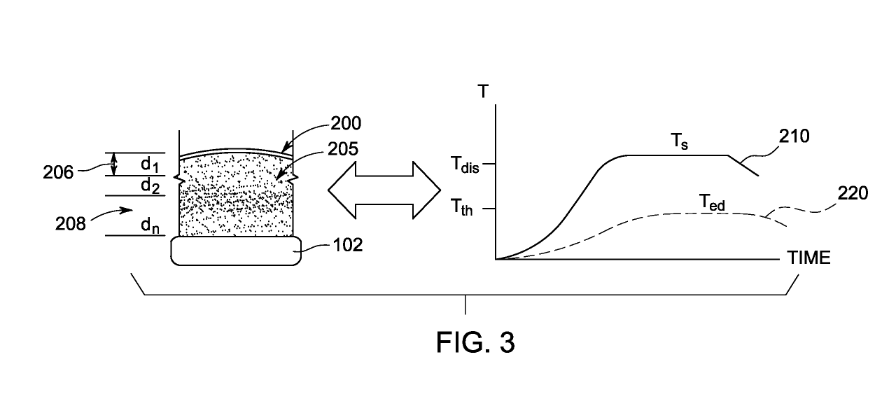

Referring now to FIGS. 2-4, the electronic device 102, energy source 175, output device 190, or external devices 195 can be sensitive to temperature. Referring to FIG. 3, the system 100 can include a thermal mass 205 located between the encapsulate film 120 and the electronic device 102. The thermal mass 205 can be operable to absorb thermal energy over the duration of disinfection of sterilization such that the electronic device 102 and/or external devices 195 remain at or below their threshold temperature damage point by virtue of heat absorption in the thermal mass 205. A material composition of the thermal mass 205 can be selectable of a variable density (d1, d2, . . . dn) 206 as a function of distance or depth 208 from the encapsulate film 120 or electronic device 102 so as to allow the encapsulate film 120 to reach and stay at the requisite temperatures while the electronic device 102 also retains its design temperature range.

FIG. 3 illustrates an embodiment of a surface temperature (Ts) profile 210 as a function of time of the encapsulating film 215 or electronic device 102 enclosed therein or the external device 195 for a threshold disinfection (Tdis) level for a threshold duration to accomplish disinfection or sterilization before release of the electronic device 102 enclosed in the encapsulate film 120 for use in association with another object 110. Yet, the temperature (Ted) 220 of the electronic device 102 enclosed therein can be specified not to exceed a threshold temperature (Tth) having an increased probability of causing damage to the electronic device 102. The temperature (Ted) 220 of the electronic device 102 can be held below (Tt) for the duration of the cycle. The thermal mass 205 can be of a material composition of variable density 206 to absorb a differential (Ts-Tt) through the entire increments of depth 208 of the thermal mass 205 between the encapsulate film 120 and electronic device 102. At each increment of depth 208, the thermal mass 205 may be configured to be of different density 206, configured to absorb the heat so as to maintain the temperature (Ted) below the threshold temperature (Tth).

After disinfection, the electronic device 102 enclosed in the encapsulate film 120 can be made available for use with another object 110 in a similar manner as described above.

Having described a general construction of the embodiment of the system 100, the following is a general description of a method of operation of the system 100 described above. Although the method is described in accordance to the following acts, it should be understood that the sequence of the acts can vary. Also, it should be understood that the following description of acts is not limiting, and that one or more of the described acts may not be needed.

The method can include enclosing the electronic device 102 in the system 100, such that dirt, a cleaning solvent, and bacterial contamination generally do not penetrate through the system 100 and make contact with the electronic device 102. An embodiment of the system 100 can be reduced in size or shrunk to wrap around the electronic device 102. Assume for sake of example that the electronic device 102 includes a tracking device 105 (e.g., RFID or infrared tag). The method of enclosing the tracking device 105 can include immersing the tracking device 105 into a solvent-impermeable casing, where casing is soft or hard, so as to form the encapsulate film 120 around the tracking device 105. The encapsulate film 120 can include the ability to incorporate straps or other mechanical connection device 165 to perform a wearable function to attach to the band 140. The encapsulate film 120 can be fabricated from a material composition that is chemically resistive against penetration of disinfection solvents employed to disinfect in a healthcare environment or clinic setting.

The method can further include providing the band 140 with the pocket portion 150 to receive the encapsulate film 120 and enclosed electronic device 102. The embodiment of the band 140 can include a tubular type form of plastic material composition configured to receive the appendage 142 of the person therethrough. The pocket portion 150 can be integrally constructed to or attached by the mechanical connection device (e.g., adhesive, Velcro, buckle, etc.) 165 to the band 140. The flap portion 155 can be coupled to generally overlap the pocket portion 150. With insertion of the encapsulate film 120 and enclosed tracking device 105 in the open end 160 of the pocket portion 150, the flap portion 155 can be folded over the opening to enclose the encapsulate film 120 and tracking device 105 in the pocket portion 150 of the band 140. The material composition of the band 140 and attached pocket portion 150 can be generally similar to the material composition of the encapsulate film 120 such that an application of energy (e.g., heat, chemical, etc.) can cause the flap portion 155 and pocket portion 150 to generally bond so as to seal the enclosed encapsulate film 120 and tracking device 105 from exposure to fluids (e.g., water, vapor, disinfection chemicals, etc.) or other contamination. The material composition of the encapsulate film 120 and the pocket portion 150 of the band 140 can be such that the person can visualize the identity of the tracking device 105 enclosed therein. With insertion of the appendage 142 into the band 140, an application of energy as described above can cause the band 140 to reduce in size or shrink fit around the appendage 142 in a snug manner to prevent removal. A clinician or technician can visualize and store the identity the tracking device 105 with the identity of the object 110 receiving the band 140 so as to be operable to track and store movement of the object 110 through treatment or diagnosis at the facility.

The method can include the determination of an end-of-life or change of state from relatively speaking “ready to use” to “need for cleaning/disinfection” of the system 100 or encapsulate film 120 enclosing the electronic device 102. The method can include receiving data from the electronic device 102 indicative of a number of cycles that the electronic device 102 has been tracked in use with different objects 110, or total time period that the system 100 or enclosed electronic device 102 has been in use. The method includes setting a threshold level for the number of cycles or total time that the system 100 or electronic device 102 can be safely in use. During the use of the system 100 or electronic device 102, the electronic device 102 can provide an alert that can be a periodic or a single alert about a relation between a current status and a threshold level of the end of life or time before need for cleaning of the system 100. The method can include an alert action without a preset threshold level for the number of cycles or total time that the system 100 or electronic device 102. According to this method, the electronic device 102 can provide an alert to a user, to a central control station, and/or to an external interface that can be associated with the medical facility where the system 100 is operated.

The method can include a detection of a disinfection condition (e.g., “ready for use” on another object 110 versus “need for disinfection” before use by another object 110) based on a time that the system 100 or the electronic device 102 is positioned into a disinfection environment. According to this method, the electronic device 102 can provide an alert about the disinfection condition to a user, to a central control station, and/or to another communication interface (e.g., pager, phone, visual monitor, etc.) associated with the medical facility where the system 100 is operated. According to the method, this alert can allow or dis-allow performance of follow-up actions, with non-limiting examples such as open the disinfection chamber, open the door into an operation room, and others.

A system for detection of the end-of-life of the system 100 can include the tracking device 105 and a time reference component of the end-of-life of the system 100. Nonlimiting examples of the electronic device 102 can include the passive and active tracking device 105 operating at about 110-150 KHz, 13.56 MHz, 800-990 MHz, 2.45 GHz. Nonlimiting examples of the time reference can include reference to an internal clock or a reference to an indication of a time that is wirelessly transmitted from a network computer or smart mobile device.

The method for detection of the end-of-life of the system 100 can be based on the amount of residual disinfection medium (for example, steam, solvent) that has penetrated into the electronic device 102 or based by the amount of degradation produced by the disinfection medium (for example, steam, solvent, gas, ionizing radiation) that affects the electronic device 102. According to this method, the system 100 can detect the end-of-life of the system 100 by detection of a change in the state of the tracking device 105. According to the method, the electronic device 102 can include a sensor or similar detection device of a contact with or threshold measure of a residual disinfection solvent or medium and/or for detection of the amount of degradation produced by the disinfection medium.

The system for the determination of the end-of-life of the system 100 can include the external device 195 being a sensor in communication via a wired link or wireless coupling (See FIGS. 4 and 5) 200 to the electronic device 102. The external device 195 can be responsive to a detected or threshold measured amount of residual disinfection medium that has penetrated into the tracking device 105 or based by detection or measure of threshold amount of degradation produced by the disinfection solvent or medium that damages or otherwise detrimentally affects performance of the electronic device 102. The eternal device 195 can generate the alert via detection or measure of threshold color change, a dielectric change, or a dimension change of a sensing film associated with the external device 195 in response to contact with the disinfection solvent or medium.

Thereby, the system 100 generates of an output via the external device 195 for illustration to a user indicative of an of the end-of-life of the system 100, or an output for illustration to a user indicative of a measure of degradation of the system 100 relative to a threshold, or an output of a disinfection status (e.g., clean versus dirty) of the system 100 for illustration to user.

Upon time to end tracking of the person or medical device, removal of the system 100 can include cutting the band 140 to release or remove from the appendage 142 or object 110. The band 140 can be disposed of while the encapsulate film 120 and enclosed tracking device 105 can be retained, disinfected and used again. Disinfection of the encapsulate film 120 and enclosed tracking device 105 can include cutting the pocket portion 150 of the band 140 to remove the encapsulate film 120 and enclosed tracking device 105, without disturbing the construction of the encapsulate film 120 around the tracking device 105, and applying disinfectant or other cleaning solution at the encapsulate film 120 and enclosed tracking device 105. Applying disinfectant or other cleaning solution can include wiping or immersion of the encapsulate film 120 and enclosed tracking device 105 in the disinfectant or cleaning solution. For example, the encapsulate film 120 and enclosed tracking device 105 can be completely immersed in the disinfectant solvent or medium (e.g., CIDEX™) for a threshold period of time. The encapsulate film 120 prevents the disinfectant from penetrating and making contact with the enclosed tracking device 105 that would otherwise increase the likelihood of corroding or otherwise damaging the tracking device 105 and thereby prevent subsequent re-use of the tracking device 105 with another person. The encapsulate film 120 and enclosed tracking device 105 can also be sterilized by immersion in steam vapor for a threshold time period.

A technical effect of the subject matter described herein includes providing a low cost, highly flexible system 100 that reduces the need for special procedures for special cleaning and/or sterilization processes on the enclosed objects (e.g., tracking devices 105) 110. The system 100 can lower purchase costs of additional tracking devices 105 and disposal costs in response to failures associated with immersion of tracking devices 105 in disinfectant or undergoing sterilization prior to use in tracking objects 110 (e.g., persons or medical equipment) through a facility. Furthermore, a technical effect of the system 100 can include accommodating multiple types of tracking devices 105 associated with different modalities, etc.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system to receive a portable tracking device on an object, comprising:
an encapsulate film surrounding the portable tracking device; and
a band having a pocket portion with an open end to receive the portable tracking device and encapsulate film, the pocket portion further comprising a flap that folds over the open end of the pocket portion, wherein the encapsulation film can be removed from the band and cleaned without removal of the portable tracking device from the encapsulate film.

2. The system of claim 1, wherein the film is of a material composition that in response to a threshold application of heat then shrinks and encapsulates the portable tracking device from exposure to a fluid.

3. The system of claim 1, wherein the film is of a material composition that in response to a threshold application of intensity of light then shrinks and encapsulates the portable tracking device from exposure to a fluid

4. The system of claim 1, wherein the film is of a translucent material composition that allows the person visualization of an identifier of the portable tracking device enclosed therein.

5. The system of claim 1, wherein the pocket portion is of a translucent material composition that allows the person visualization of an identifier of the portable tracking device enclosed therein.

6. The system of claim 1, wherein a mechanical connector retains the flap folded over the open end of the pocket portion.

7. The system of claim 1, wherein the pocket portion is integrally constructed with the band.

8. The system of claim 1, wherein the pocket portion is attached at the band by a mechanical connector.

9. The system of claim 1, wherein the band comprises a tubular material configured to wrap around an appendage of the object to wear the portable tracking device.

10. The system of claim 1, wherein the pocket portion is of a material composition that reduces in size or shrinks in response to receiving an application of a threshold energy.

11. A system to receive a portable electronic device on an object, comprising:
an encapsulate film surrounding the portable electronic device; and
a band having a pocket portion with an open end to receive the portable electronic device and encapsulate film, the pocket portion further comprising a flap that folds over the open end of the pocket portion, wherein the encapsulation film can be removed from the band and cleaned without removal of the portable electronic device from the encapsulate film.

12. The system of claim 11, wherein the encapsulate film is of a material composition that in response to a threshold application of heat then shrinks and encapsulates the portable electronic device from exposure to a fluid.

13. The system of claim 11, wherein the encapsulate film is of a material composition that in response to a threshold application of intensity of light then shrinks and encapsulates the portable electronic device to prevent exposure to a fluid.

14. The system of claim 11, wherein the encapsulate film is of a translucent material composition that allows the person visualization of an identifier of the portable electronic device enclosed therein.

15. The system of claim 11, wherein the pocket portion is of a translucent material composition that allows visualization of an identifier of the portable electronic device enclosed therein.

16. The system of claim 11, further comprising a thermal mass of different material composition than the encapsulate film and the portable electronic device, the thermal mass located between the encapsulate film and the portable electronic device, wherein the thermal mass is of a variable density to absorb thermal energy penetrating the encapsulate film before reaching the portable electronic device.

17. The system of claim 11, further comprising a wireless coupling to provide communication between an external device outside the encapsulate film and the portable electronic device enclosed within the encapsulate film.

18. The system of claim 11, wherein the system generates an output for illustration to a user of an end-of-life of the system.

19. The system of claim 11, wherein the system generates an output for illustration to a user of a measure of degradation of the system.

20. The system of claim 11, wherein the system generates an output of a disinfection status of the system for illustration to user.
